(19) United States
(12) Patent Application Publication
(10) Pub. No.: US 2008/0184886 A1
(43) Pub. Date: Aug. 7, 2008

(54) THERMAL PRECONCENTRATOR FOR COLLECTION OF CHEMICAL SPECIES

(75) Inventors: Jenia A. Tufts, Raleigh, NC (US); Anthony L. Andrady, Apex, NC (US); Teri A. Walker, Durham, NC (US); David S. Ensor, Chapel Hill, NC (US)

Correspondence Address: OBLON, SPIVAK, MCCLELLAND MAIER & NEUSTADT, P.C., 1940 DUKE STREET, ALEXANDRIA, VA, 22314, US

(73) Assignee: Research Triangle Institute, Research Triangle Park, NC (US)

(21) Appl. No.: 11/670,774

(22) Filed: Feb. 2, 2007

(51) Int. Cl. B01D 53/02

(52) U.S. Cl. 95/148; 95/90; 96/146; 977/833

(57) ABSTRACT

A thermal preconcentrator unit and a method for concentrating chemical species. The thermal preconcentrator unit includes a thermoelectric device having a temperature controlled surface and a sorbent material configured to concentrate the chemical species. The sorbent material is disposed on and in thermal contact with the temperature controlled surface. The thermoelectric device is configured to cool and heat the temperature controlled surface to promote sorption and desorption of chemical species onto and from the sorbent material. The method provides a temperature controlled surface and exposes the chemical species to a sorbent material disposed on the temperature controlled surface to concentrate the chemical species thereon.

### CROSS REFERENCE TO RELATED APPLICATIONS

This application is related to U.S. application Ser. No. 10/819,942, filed on Apr. 8, 2004, entitled “Electrospray/Electrospinning Apparatus and Method,” Attorney Docket No. 241013US-2025-2025-20, the entire contents of which are incorporated herein by reference. This application is related to U.S. application Ser. No. 10/819,945, filed Apr. 8, 2004, entitled “Electrospinning in a Controlled Gaseous Environment,” Attorney Docket No. 241016US-2025-2025-20, the entire contents of which are incorporated herein by reference. This application is related to U.S. application Ser. No. 11/130,269 filed on May 17, 2005, entitled “Nanofiber Mats and Production Methods Thereof,” Attorney Docket No. 256964 US-2025-2025-20, the entire contents of which are incorporated herein by reference. This application is related to U.S. application Ser. No. 11/559,282, filed on Nov. 13, 2006, entitled “Filter Incorporating Nanofibers,” Attorney Docket No. 28373US-2025-2025-20, the entire contents of which are incorporated herein by reference.

### STATEMENT REGARDING FEDERALLY SPONSORED RESEARCH

The U.S. Government, by the following contract, may have a paid-up license in this invention and the right in limited circumstances to require the patent owner to license others on reasonable terms, as provided for by the terms of DARPA Contract No. HR0011-04-C-0084.

### BACKGROUND OF THE INVENTION

1. Field of the Invention

This application is directed to systems and methods for sensing and identifying chemical compounds.

2. Description of the Related Art

Chemical preconcentrators are used to detect a variety of chemicals including pollutants, high explosives, and chemical warfare agents. Related art chemical preconcentrators include a substrate having a suspended membrane formed thereon. A resistive heating element is disposed on the surface of the membrane, and a sorptive material is disposed on at least one surface of the membrane to sorb and concentrate at least one chemical species of interest from a vapor over time.

The chemical species is then released from the sorptive material, by for example, heating the sorptive material to create an identifiable concentration of the chemical of interest. Related art sorptive materials may include microporous materials, sol gel oxides, and polymers. Chemical modification of the surface of the sorptive material can be used to enhance sorption of the chemical species of interest. By accumulating and concentrating one or more chemical species of interest over time and then rapidly releasing concentrated chemical species for chemical analysis, by for example gas chromatography, chemicals may be identified. Some related art chemical preconcentrators are discussed below.

U.S. Pat. No. 6,455,003, entitled “Preconcentrator for Chemical Detection,” the entire contents of which are incorporated herein by reference, describes tubular preconcentrators in which a chemical species is pumped through a sorbent material, and after sorption, a gas flow purges the sorbent material of the chemical species during a heating event.

U.S. Pat. No. 6,171,378, entitled “Chemical Preconcentrator,” the entire contents of which are incorporated herein by reference, describes a membrane preconcentrator in which a sorptive material is coated on a silicon nitride layer encasing a resistance heater.

U.S. Pat. No. 5,481,110, entitled “Thin film preconcentrator array,” the entire contents of which are incorporated herein by reference, describes a preconcentrator array formed upon a semiconductor substrate upon which a dielectric membrane has been deposited. An absorber is provided on the membrane for collecting and concentrating the gas to be sampled. A heater is provided on the membrane for the release of an absorbed gas from the absorber.

### SUMMARY OF THE INVENTION

In one embodiment of the present invention, there is provided a thermal preconcentrator unit including a thermoelectric device having a temperature controlled surface and including a sorbent material configured to concentrate the chemical species. The sorbent material is disposed on and in thermal contact with the temperature controlled surface. The thermoelectric device is configured to cool and heat the temperature controlled surface to promote sorption and desorption of chemical species onto and from the sorbent material.

In another embodiment of the present invention, there is provided a thermal preconcentrator unit including a heating and cooling device having a temperature controlled surface and including a nanonfiber medium having nanofibers of an average fiber diameter less than 1 micron, disposed on and in thermal contact with the temperature controlled surface, and configured to concentrate a chemical species. The heating and cooling device is configured to cool and heat the temperature controlled surface to promote sorption and desorption of the chemical species onto and from the nanofiber medium.

In another embodiment of the present invention, there is provided a method for concentrating chemical species. The method provides a thermoelectric temperature controlled surface and exposes the chemical species to a sorbent material disposed on the temperature controlled surface to concentrate the chemical species thereon.

In another embodiment of the present invention, there is provided a method for concentrating chemical species in which the method provides a temperature controlled surface and exposes the chemical species to a nanonfiber medium disposed on the temperature controlled surface to concentrate the chemical species thereon. The nanonfiber medium includes nanofibers of an average fiber diameter less than 1 micron.

In another embodiment of the present invention, there is provided a system for concentrating and detecting chemical species. The system includes a gas feed configured to supply the chemical species, a thermoelectric device having a temperature controlled surface, and a sorbent material configured to concentrate the chemical species. The sorbent material is disposed on and in thermal contact with the temperature controlled surface. The thermoelectric device is configured to cool and heat the temperature controlled surface to promote sorption and desorption of chemical species onto and from the sorbent material. The system includes a chemical detector configured to detect the chemical species upon desorption from the sorbent material.

It is to be understood that both the foregoing general description of the invention and the following detailed description are exemplary, but are not restrictive of the invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic illustration of an electrospinning apparatus and a thermoelectric unit according to an exemplary embodiment of the invention;

FIG. 2 is a schematic illustration, according to one embodiment of the present invention, showing an electrospinning apparatus that supports a grounded thermoelectric unit;

FIG. 3 is a schematic illustration of a thermoelectric unit according to another embodiment of the invention;

FIG. 4 is a flowchart depicting a method of detecting a chemical species of interest according to one embodiment of the invention.

FIG. 5 is a schematic illustration of a thermoelectric unit according to another embodiment of the invention;

FIG. 6 is a schematic illustration of a thermoelectric unit according to another embodiment of the invention;

FIG. 7 is a schematic illustration of a preconcentrator system according to another embodiment of the invention;

FIG. 8 is a schematic illustrating the desorption of separate species from a sorption material at different temperatures;

FIG. 9 is a schematic illustrating a variety of thermoelectric cooling and sorption material combinations possible in various embodiments of the present invention;

FIG. 10 is a schematic illustration of a preconcentrator chamber according to one embodiment of the present invention;

FIG. 11 is a schematic illustration of another preconcentrator chamber according to one embodiment of the present invention; and

FIG. 12 is a graph of detected species in the gas phase detected by gas chromatography.

### DETAILED DESCRIPTION OF THE INVENTION

The ability to concentrate adsorbed or adsorbed species to a substantial degree is dependent on the surface area of the sorbent material and more particularly to the surface area to volume ratio of the sorbent material. The larger the surface area to volume ratio, the more of the sorbed species that can be pre-concentrated on the sorbent material. Accordingly, in one embodiment, the present invention (while not restricted to sorbent materials with large surface area to volume ratio) uses materials such as particles, nanoparticles, fibers, and nanofibers for example as a sorbent material having a large surface to volume ratio.

Absorption in particular is enhanced with high surface area: to volume ratio, in terms of kinetics of absorption. More of the volume is available at a shorter distance from the surface, so absorption occurs faster (i.e., the chemical species being absorbed does not have to travel as far to get to the middle of the sorbent. Adsorption in particular is enhanced due to the sorbent material having a large surface area for the sorbed species to collect on. Sorbed species in the present invention unless otherwise specified refer to either one or both adsorption and absorption events on a sorbent material.

Nanofibers have been found to be useful in a variety of fields from clothing industry to military applications. For example, in the biosubstance field, there is a strong interest in developing structures based on nanofibers that provide a scaffolding for tissue growth effectively supporting living cells. In the textile field, there is a strong interest in nanofibers because the nanofibers have a high surface area per unit mass that provides light but highly wear-resistant garments. As a class, carbon nanofibers are being used for example in reinforced composites, in heat management, and in reinforcement of elastomers. Many potential applications for nanofibers are being developed as the ability to manufacture and control the chemical and physical properties improves.

Electrospray/electrospinning techniques have been used to form particles and fibers as small as one nanometer in a principal direction. Electrospun nanofibers have a dimension less than 1 μm in one direction and preferably a dimension less than 100 nm. Nanofiber webs have typically been applied onto various substrates selected to provide appropriate mechanical properties and to provide complementary functionality to the nanofiber web. In one embodiment of the present invention, such nanofiber based materials provide sorbent materials with a large surface area to volume ratio (as discussed above).

The phenomenon of electrospray involves the formation of a droplet of polymer melt at an end of a needle, the electric charging of that droplet, and an expulsion of parts of the droplet because of the repulsive electric force due to the electric charges. In electrospraying, a solvent present in the parts of the droplet evaporates and small particles are formed but not fibers. The electrospinning technique is similar to the electrospray technique, but differs in the formation of fibers from an electric field extracted medium (such as for example from a polymeric solution or a polymer melt).

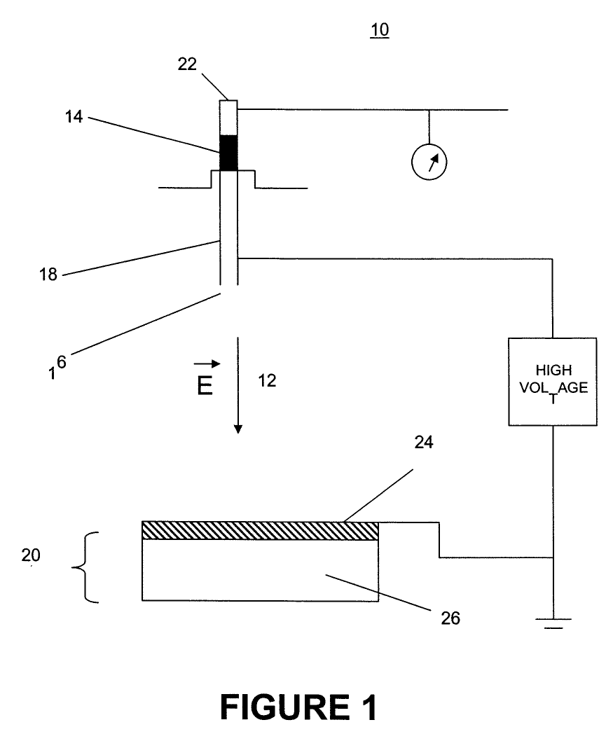

Referring now to the drawings, wherein like reference numerals designate identical or corresponding parts throughout the several views, an electrospinning apparatus 10 is shown in FIG. 1 for the production of nanofibers. The apparatus 10 produces an electric field 12 that guides a polymer melt or solution 14 extruded from a tip 16 of an electrospinning element 18, for example a tube or a capillary. An enclosure/syringe 22 stores the polymer solution 14. One end of a voltage source H/V is electrically connected directly to the electrospinning element 18, and the other end of the voltage source H/V is electrically connected to ground. The electric field 12 created at the tip 16 causes the polymer solution 14 to overcome cohesive forces that hold the polymer solution together. A jet of the polymer 14 is drawn from the tip 16 toward the electrode 20 by the electric field 12 (i.e. electric field extracted), and dries during flight from the needle 18 to form polymeric fibers. The fibers are typically collected downstream on electrode 20, shown in FIG. 1 as a composite structure having a topmost part 24 (i.e., a substrate) collecting the fibers in which the substrate 24 can be detached from a bottom part 26.

Examples of fluids suitable for electrospraying and electrospinning include molten pitch, polymer solutions, polymer melts, polymers that are precursors to ceramics, and/or molten glassy substances. These polymers can include nylon, fluoropolymers, polyolefins, polyimides, polyesters, acrylics, rubbers, vinyls, urethanes, silicones, natural polymers such as proteins, carbohydrates and DNA, and any other suitable engineering polymers or textile forming polymers. A variety of fluids or substances besides those listed above have been used to make fibers including pure liquids, solutions of fibers, mixtures with small particles and biological polymers. A review and a list of the substances used to make fibers are described in U.S. Patent Application Publications US 2002/0090725 A1 and US 2002/0100725 A1, and in Huang et al, Composites Science and Technology, v63, 2003, the entire contents of which are incorporated herein by reference.

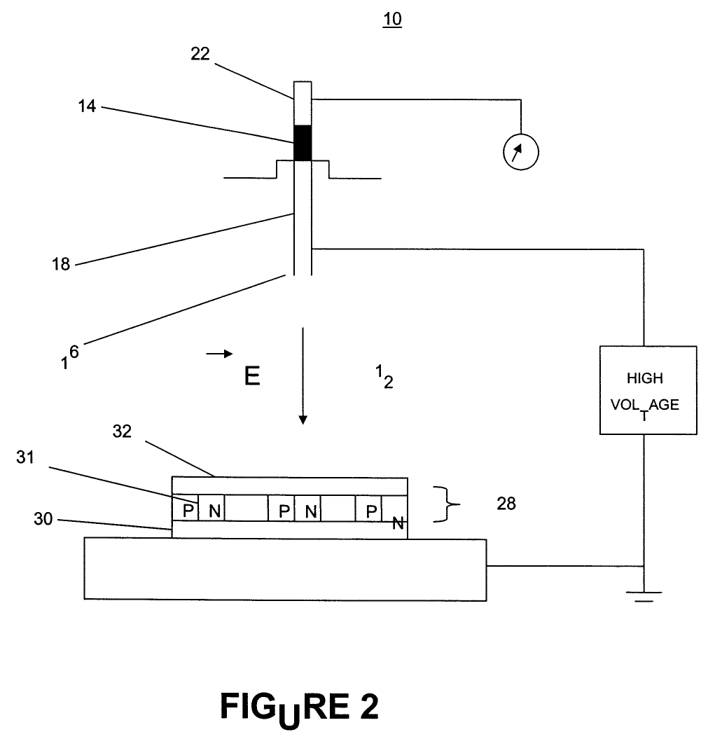

FIG. 2 is a schematic illustration, according to one embodiment of the present invention, showing an electrospinning apparatus configuration in which a thermoelectric unit 28 is used as the collector of fibers. Typical thermoelectric units include semiconductor pairs 31 (known as Peltier pairs) which have been doped so that either the positive or negative charge carrier carries the majority of current and forms P-N junctions. Pairs of P/N junctions are connected electrically in series but thermally in parallel. When a DC voltage is applied to the unit, positive and negative charge carriers in the semiconductor pairs absorb heat energy from one substrate surface and release it to the substrate on the opposite side. The surface where heat energy is absorbed becomes cold and the opposite surface, where heat energy is released, becomes hot. Off the shelf thermoelectric units operate at subambient as well as elevated temperatures (e.g., from −100° C. to 150° C.) so that a broad range of materials can be used to make the nanofibers, and are available for use in the embodiments of the present invention. Examples of units with high temperature limits include the HT series produced by Melcor Corporation or the 9500 series produced by Ferrotec Corporation. In one embodiment of the present invention, a metallic coating such as for example gold can be coated onto the ceramic surface of the thermoelectric cooler to provide a ground reference for the thermoelectric cooler.

In FIG. 2, electrospinning apparatus 10 produces an electric field 12 that guides a polymer melt or solution 14 extruded from a tip 16 of an electrospinning element 18 to the thermoelectric device 30, which may be grounded. The polymer solution/melt 14 is stored in enclosure/syringe 14. One end of a voltage source H/V is electrically connected to needle 18 and the other end of the voltage source H/V is connected either to the thermoelectric device 30 conductive coating 34 directly or to the grounded collection plate 40. The electric field 12 created between the tip 16 and the thermoelectric device 30 causes the polymer solution 14 to overcome cohesive forces that hold the polymer solution together. A jet of polymer is drawn from the tip toward the thermoelectric device 30 by the electric field and partially dries during flight from the electrospinning element 16 to the thermoelectric unit to form polymeric fibers on the surface 32 of the thermoelectric device 30. The solvent/heat plasticized polymer of the nanofiber adheres to the surface 32 (or the substrate 24 shown in FIG. 1) by molding to surface irregularities.

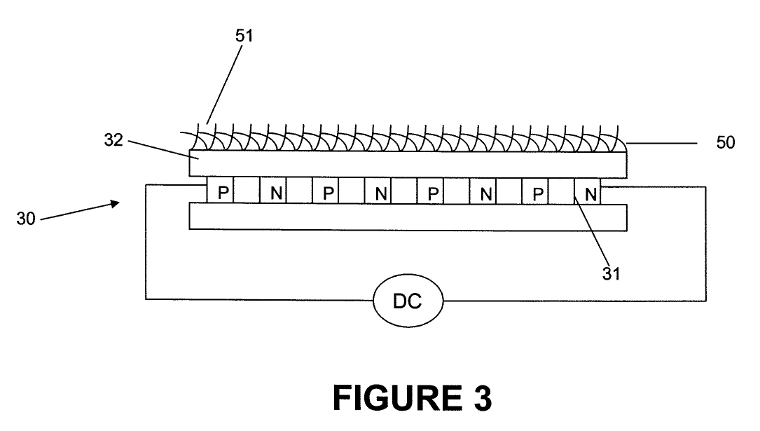

As shown in FIG. 3, a mat 50 of nanofibers is disposed on the surface 32 of the thermoelectric unit. In one embodiment of the invention, nanofibers are directly electrospun onto the surface of the thermoelectric unit providing good adherence and facilitating heat transfer between the thermoelectric surface and the nanofibers. Alternatively, the fibers could be disposed on for example substrate 24, as shown in FIG. 1, and the substrate thermally fixed to a thermoelectric device 28. Alternatively, a preformed sorbent (including for example a fiber mat, a plurality of particles, a film, and a combination thereof, and including nanofibers and nanoparticles) could be attached the thermoelectric device using an adhesive layer. Alternatively, a sorbent including a plurality of particles and/or a film of organic or inorganic material could de deposited on the thermoelectric device 28 using known coating and particle applicators.

In one embodiment of the present invention, the thermoelectric surface 32 or the surface of substrate 24 can be purposely roughened for better adhesion. The surface in one embodiment of the present invention would have rough features with a size on the order of at least 5% of the size of the sorbent fiber or particulate diameter. The surface features in one embodiment of the present invention would be as large as ˜100 μm. The surface of substrate 24 could be preselected to be a material that has a rough surface character. Alternatively or cumulatively, materials coated on the thermoelectric surface can be used to enhance physical attraction between fibers and surface or in general between the organic or inorganic sorbent materials and the substrate 24. The coating could be a thermally conductive adhesive material, for example cement, gum, epoxy, cyanoacrylate, thermally conductive glue or grease. Another method of adhesion includes using loose wire mesh to hold the mat 50 to surface.

As illustrated in FIG. 3, a preconcentrator according to one embodiment of the present invention includes: a mat 50 of fibers in contact with the surface of a temperature controlled device such as for example thermoelectric device 30 (which can be a Peltier module). The thermoelectric device 30 is set to heat or cool the fiber mat by adjusting the polarity of the power source connected to it. The term “fiber mat” is used herein to define a plurality of fibers produced by forming fiber after fiber on each other. Respective fibers in the fiber mat can intermingle or be separate from other fibers in the fiber mat. Since, the fibers are in thermal contact with the thermoelectric unit, the temperature of the fibers owing to their small mass can be rapidly and actively cooled to subambient temperatures rather than relying on (relatively slow by comparison) passive cooling to ambient temperatures. Active cooling allows below-ambient temperatures to be reached. Fiber adherence to the heating/cooling surface may be enhanced by directly electrospinning the nanofibers onto the heating/cooling surface. Good heat transfer between the thermoelectric surface and the nanofibers also facilitates efficient and rapid heating.

A variety of materials are available to be electrospun onto the thermoelectric substrate surface. In addition to electrospinning pure polymeric materials, blends of polymers can be used, or polymers or blends of polymers with dissolved or suspended additives can be used. Electrospinning can be performed from a solution with one or more solvents, or from the melt.

The present invention has determined that placing a pre-spun fiber mat on a surface of a thermoelectric unit is not sufficient in all cases. A pre-spun mat does not adhere easily to the thermoelectric surface, and an insulating air layer may exist between the nanofiber mat and the thermoelectric surface that impedes heat transfer to and from the nanofibers. One advantage to electrospinning directly onto the thermoelectric surface is that the residual electrostatic charge in the nanofibers aids in the adhesion of the nanofibers to the thermoelectric surface.

Electrospinning is performed so that the fibers land directly on the surface of the thermoelectric unit. During electrospinning from a solvent or solvent mixture, a small amount of solvent remains in the fibers as the electrospun fibers land on the thermoelectric surface. This is accomplished by setting the operating parameters to keep some solvent remaining in the polymer phase as the fibers land on the substrate (parameters: tip to cathode distance, flow rates, temperature, chamber evacuation rate, etc.) One procedure is given for illustrative purposes below to illustrate selection of the polymer, solvent, a gap distance between a tip of the extrusion element and the collection surface, solvent pump rate, and addition of electronegative gases for the production of a nonofiber mat:

a polystyrene solution of a molecular weight of 350 kg/mol,

a solvent of dimethylformamide DMF,

an extrusion element tip diameter of 1000 nm,

an Al plate collector,

˜0.5 ml/hr pump rate providing the polymer solution,

an electronegative gas flow of CO₂ at 8 lpm,

an electric field strength of 2 kV/cm, and

a gap distance between the extrusion element tip and the collector of 17.5 cm.

Besides electrospinning from a solution, electrospinning can occur from a polymer melt that is extracted from the tip of the extrusion element and spun directly onto the thermoelectric surface works. In this embodiment, the fibers are heat-plasticized rather than solvent-plasticized. The materials used to electrospin from the melt are the same as those electrospun from solution (see list below). Electrospinning from the melt is desirable when the polymer is not readily dissolved in a solvent or if it is desired to avoid the use of solvents, such as for example in order to avoid producing waste solvent. The following example illustrates the electrospinning of fibers from the melt directly onto a thermoelectric unit.

a polysulfone material of a molecular weight of 30 kg/mol,

a melt temperature of 350° C.,

an extrusion element tip diameter of 1000 μm,

an Al plate collector,

˜0.5 ml/hr pump rate providing the polymer solution,

an electronegative gas flow of CO₂ at 8 lpm,

an electric field strength of 2 kV/cm, and

a gap distance between the tip of the extrusion element and the collector of 17.5 cm.

The solvent-plasticized polymer of the fibers and nanofibers in one embodiment of the present invention can mold to the irregularities in the thermoelectric surface, providing better contact between the nanofibers and the surface. This enhances adhesion as well as heat transfer between the nanofibers and the thermoelectric surface. While a fully assembled thermoelectric device module may be heat sensitive at polymer melt temperatures given above, the outer surface of the thermoelectric device module is less heat sensitive than the complete thermoelectric device module. In one embodiment of the present invention, the fibers can be electrospun onto the outer surface material. Then, this surface with the electrospun fibers is attached to a temperature-controlled stage of the thermoelectric device module.

Further, retarding the drying or coalescing rate is considered advantageous because the longer the residence time of the fiber in the region of instability, the lower the electric field strength can be while still prolonging the stretching, and consequently improving the processing space for production of nanofibers. The drying rate for an electrospun fiber during the electrospining process can be adjusted by altering the partial pressure of the solvent vapor in the gas surrounding the fiber.

For instance, when a solvent, such as methylene chloride or a blend of solvents, is used to dissolve the polymer, the rate of evaporation of the solvent will depend on the vapor pressure gradient between the fiber and the surrounding gas. The rate of evaporation of the solvent can be controlled by altering the concentration of a solvent vapor in the gas. The rate of evaporation also affects the Rayleigh instability. Additionally, the electrical properties of the solvent (in the gas phase) influence the electrospinning process. As discussed in related application, “Electrospinning in a Controlled Gaseous Environment,” by maintaining a liquid pool at the bottom of the chamber, the amount of solvent vapor present in the ambient about the electrospinning environment can be controlled by altering a temperature of the chamber and/or the solvent pool, thus controlling the partial pressure of solvent in the gaseous ambient in the electrospinning environment. Examples of temperature ranges and solvents suitable for the present invention are discussed below.

For temperature ranges from ambient to approximately 10° C. below the boiling point of the solvent, the following solvents are suitable:

Dimethylformamide: ambient to ˜143° C.

Methylene chloride: ambient to ˜30° C.

Water: ambient to ˜100° C.

Acetone: ambient to ˜46° C.

Solvent partial pressures can vary from near zero to saturation vapor pressure. Since saturation vapor pressure increases with temperature, higher partial pressures can be obtained at higher temperatures. Quantities of solvent in the pool vary with the size of the chamber, with temperature, with the solvent being used and with the removal rate by the vent stream.

Further refinements of the electrospining process are described in U.S. Application Ser. No. 11/559,282, filed on Nov. 13, 2006, entitled “Filter Incorporating Nanofibers,” Attorney Docket No. 28373US-2025-2025-20, previously incorporated herein by reference. The practices described there can be used in the present invention to produce small diameter nanofibers whose large surface to volume ratio will enhance the sorption of chemical species in the various preconcentrators of the present invention.

In one embodiment of the present invention, stainless steel extrusion tips having internal diameters (ID) from 0.15 to 0.58 mm are used. In another refinement, Teflon capillary tubes with ID from 0.07-0.30 mm are used. Both types of orifices can produce submicron fibers. For both orifices, low flow rates coupled with high voltage drops typically resulted in the smallest fiber diameters (e.g, <200 nm). In both cases, the voltage was 22 kV to 30 kV for a 17.8-25.4 cm gap (i.e., the distance between tip 16 and electrode 20). In one embodiment of the present invention, the voltage per gap is a parameter providing pulling strength for the electrospinning. The gap in part determines travel time of the electrospun fiber to the collector, and thus determines stretching and solvent evaporation times. In one embodiment of the present invention, different CO₂ purge flow rates around needle 18 (i.e., as a gas jacket flow around and over the tip 16 in the fiber pull direction) for the different spinning orifices are utilized to improve the electrospun fibers.

When stainless steel needles were used, higher gas flow rates of CO₂ (e.g., increasing from 8 lpm to 13 lpm) typically resulted in improved fibers with smaller diameters. Reductions of 30 to 100 nm in AFD were observed, permitting (in most cases) fibers with AFD less than 200 nm to be achieved by these methods of the present invention.

In contrast, when Teflon capillary tubes were used, the fiber quality was usually degraded with increasing CO₂ flow rate from 8 lpm to 13 lpm. The number of beads and other fiber defects increased. For Teflon capillary tube, a flow rate of about 8 lpm is suitable for small (less than 200 nm) diameter fibers, whereas a higher flow rate is suitable for stainless steel capillary tubes. The values for electronegative gas flow rates (in this case CO₂) given here are only examples, other gas flow rates may be used given the combination of electrospinning orifice, polymer formulation, and electrospinning conditions used in order to obtain small diameter nanofibers.

In one embodiment of the present invention, the relative humidity RH of the electrospinning chamber also effects fiber morphology. In one example, using 21 wt % PSu in DMAC, a high RH>65%, resulted in fibers that had very few defects and smooth surfaces but larger diameters, as compared to electrospun fibers produces at RH>65%.. Low RH<13%, resulted in smaller fibers but having more defects (e.g., deviations from smooth round fibers). Modestly low RH, 40% to 22%, typically produced a small fiber size with fewer defects.

A variety of mechanisms to control the chamber RH are available, according to various embodiments of the present invention, from placing materials that absorb (e.g. calcium sulfate) or emit water moisture (e.g., hydrogels) in the electrospinning chamber, operating a small humidifier in the chamber, or other ways of introducing moisture into the electrospinning chamber. For example, suitable results were obtained by bubbling CO₂ through deionized water and then introducing the humidified gas into the chamber. Two gas streams (one humidified and one dry) can be used to obtain a desired RH for the chamber and/or for the gas jacket flowing over the electrospinning orifice.

Thus, in one example of the present invention, a combination of a Teflon capillary tube, an 8 lpm CO₂ purge rate, under a RH of 30%, using PSu in DMAC produced nanofibers with an AFD of less than 100 nm. While a combination of a stainless steel capillary tube, a 13 lpm CO₂ purge rate, under a RH of 30%, using PSu in DMAC produced nanofibers with an AFD of less than 100 nm.

In another example of the present invention, nanofibers were electrospun with a solution of 21 wt % PSu in N,N-dimethylacetamide (DMAC), with the solution containing 0.2 wt. % of the surfactant tetra butyl ammonium chloride (TBAC). The surfactant lowers the surface tension and raises the ionic conductivity and dielectric constant of the solution. The polymer solution was spun from a 30 G (ID 0.154 mm) stainless steel needle with a flow rate of 0.05 ml/hr, a gap of 25 cm between the needle and target, an applied potential of 29.5 kV DC, a CO₂ gas jacket flow rate of 6.5 lpm, and an RH in the range of 22 to 38%. Inspection by SEM indicated an average fiber diameter (AFD) of 82±35 nm with the smallest fibers being in the 30 to 40 nm range.

In another example, polycarbonate PC can be spun from a 15 wt % solution of polymer in a 50/50 solution of tetrahydrofuran (THF) and N,N-dimethyl formamide (DMF) with 0.06 wt % TBAC. A 30 G stainless steel needle, a polymer solution flow rate of 0.5 ml/hr, and a CO₂ flow rate of 8 lpm were used with a gap of 25.4 cm and applied potential of 25 kV to obtain sub 200 nm fibers. Inspection by SEM indicated an AFD of 150±31 nm with the smallest fibers being around 100 nm.

Other methods of forming the sorbent material on the thermoelectric unit are possible—such as preforming a fiber mat and transferring it to the thermoelectric surface while using alternative methods to make the mat adhere to the thermoelectric surface and facilitate heat transfer between the sorbent and the thermoelectric surface. The preformed mat can be attached to the thermoelectric surface as is, or could be transferred to the surface by attaching to the thermoelectric surface a substrate upon which the sorbent is already adhered.

In one embodiment of the present invention, the gas phase chemical preconcentrator of the present invention permits the identification and detection of a variety of chemicals at concentrations below detection limits of detectors. In this embodiment, an inlet dilute gas sample passes over the nanofibers which are heated/cooled by the thermoelectric unit to a temperature that promotes sorption of the dilute gaseous chemicals into the nanofiber phase. As noted previously, sorption can include adsorption as well as absorption. After sufficient amounts of the dilute chemicals have sorbed, the nanofiber mat is rapidly heated/cooled by changing the polarity of the power source to the thermoelectric unit. The temperature switch causes rapid desorption of the gaseous chemicals which are collected in a relatively small volume of carrier gas. Sorption and desorption flow rates and temperatures, and the total times allowed for sorption and desorption can be set so that the final concentration is significantly higher than the original concentration in the inlet gas stream.

The resulting concentrated sample can then be analyzed to determine the identity and quantity of the chemicals in the sample. Analysis can be performed using any suitable analytical equipment, such as a Gas Chromatography, or, the preconcentrator can be directly connected to a detector such as a mass spectrometer.

A thermal swing preconcentrator in one embodiment of the present invention heats or cools the nanofibers to increase their ability to sorb and thus concentrate a chemical species of interest. Heating is performed by providing power to the thermoelectric device 30 so that the positive and negative charge carriers in the peltier array 31 of p and n-type materials release heat energy to the substrate in contact with the nanofiber mat. Cooling is performed by providing power to the thermoelectric device 30 so that the positive and negative charge carriers in the peltier array 31 release heat energy to the substrate not in contact with the nanofiber unit and ultimately to the heat sink. Once a sufficient amount of the chemical of interest has been sorbed, the polarity of the thermoelectric unit power source may be reversed, thereby heating the substrate and desorbing the sorbed species. This results in releasing the chemical species of interest so that it may be examined to determine the chemical species or to determine a class of the chemical species (e.g., alcohols, ketone, aldehydes, alkenes, alkanes, ethers, esters, ethylenes, etc.).

By using thermoelectric coolers, the present invention in one embodiment cools and then heats the sorbent material, so lower levels can be detected, and a broader range of chemicals can be detected compared with traditional sorbent preconcentrators which do not have the ability to cool. However, the present invention is not limited to thermoelectric devices. Other heating and cooling devices can be employed to substitute for the thermoelectric coolers. For instance, a closed loop gas compression/expansion unit can be used to heat and cool a stage containing the sorbent material. Additionally, resistance or radiation heaters could be used to heat the stage to temperatures beyond which the gas compression/expansion unit could control. Alternatively, the stage could be connected to two sources of fluid at temperatures T1 and T2. By controlling the flow of these fluids through the stage, the temperature of the stage can be accurately controlled.

The following illustrative sequence illustrates one example of a thermal preconcentrator of the present invention.

sorbent material: poly(diphenylphenylene oxide)

analyte material: methylene chloride

sorbing temperature: −10° C.

sorbing time: 5 minutes

desorbing temperature: 150° C.

desorbing time: 30 seconds

The size of the device, amount of fiber mass and desorption volume can be set such that the concentration can be increased several orders of magnitude. For example, a device with the following characteristics and processing parameters could increase the concentration of an analyte from 50 ppt to greater than 50 ppb:

1 mm² sorbent covered thermoelectric surface area,

less than 2 micrograms of fibers,

a desorption volume (i.e., the volume into which the analyte is desorbed) of 1 ml

1 liter per minute sampling flowrate, and 5 minutes sampling time.

While an inert gas could be used to transport the sample to the thermal preconcentrator, the gas being supplied could be any gas containing the sorbent to be collected from the gas stream. Sampling flowrate as used above refers to the flow rate of the gas being sampled; the gas being sampled is carried directly to the preconcentrator; the gas being sampled is, for example, room air that is suspected of being contaminated with the analyte. Or, the gas being sampled could be any other gas that the user wants to test for analyte presence and concentration.

Likewise, a device with the following characteristics and processing parameters can be used to increase the concentration of an analyte from 50 ppt to greater than 50 ppb, or from 50 ppb to greater than 50 ppm:

1 cm² sorbent covered thermoelectric surface area,

less than 2 mg fibers,

desorption volume of 1 ml,

1 liter per minute sampling flowrate, and

5 minutes sampling time.

The sorbent material in the present invention may include, but are not limited to, any material able to be formed into fibers or particulates of high surface area to volume ratio and having the ability to sorb a chemical species of interest. Such polymeric materials include for example acrylonitrile/butadiene copolymer, cellulose, cellulose acetate, chitosan, collagen, DNA, protein, fibrinogen, fibronectin, nylon, poly(acrylic acid), poly(chloro styrene), poly(dimethyl siloxane), poly(ether imide), poly(ether sulfone), poly(ethyl acrylate), poly(ethyl vinyl acetate), poly(ethyl-co-vinyl acetate), poly(ethylene oxide), poly(ethylene terephthalate), poly(lactic acid-co-glycolic acid), poly(methacrylic acid) salt, poly(methyl methacrylate), poly(methyl styrene), poly(styrene sulfonic acid) salt, poly(styrene sulfonyl fluoride), poly(styrene-co-acrylonitrile), poly(styrene-co-butadiene), poly(styrene-co-divinyl benzene), poly(vinyl acetate), poly(vinyl alcohol), poly(vinyl chloride), poly(vinylidene fluoride), polyacrylamide, acrylonitrile divinylbenzene copolymers, polyacrylonitrile, acrylic ester polymers, poly(divinylbenzene/ethylene glycol dimethacrylate), polydivinylbenzene/polyethyleneimine, polyamide, polyaniline, polybenzimidazole, polycaprolactone, polycarbonate, poly(dimethylsiloxane-co-polyethyleneoxide), poly(etheretherketone), polyethylene, polyethyleneimine, polyimide, polyisoprene, polylactide, polypropylene, polystyrene, polysulfone, polyurethane, poly(vinylpyrrolidone), proteins, SEBS copolymer, silk, styrene/isoprene copolymer, divinylbenzene/vinyl pyrollidinone copolymer, divinylbenzene/vinyl pyridine copolymer, poly(ethylene glycol dimethacrylate), ethylvinylbenzene-divinylbenzene copolymer, poly(vinylpyrolidone), poly(vinylpyridine), poly(diphenylphenylene oxide), Teflon polymers, chlorofluorocarbon resins, fluorocarbon resins, and others.

Additionally, polymer blends can also be produced as long as the two or more polymers are soluble in a common solvent. A few examples would be: poly(vinylidene fluoride)-blend-poly(methyl methacrylate), polystyrene-blend-poly(vinylmethylether), poly(methyl methacrylate)-blend-poly(ethyleneoxide), poly(hydroxypropyl methacrylate)-blend poly(vinylpyrrolidone), poly(hydroxybutyrate) -blend-poly(ethylene oxide), protein-blend-polyethyleneoxide, polylactide-blend-polyvinylpyrrolidone, polystyrene-blend-polyester, polyester-blend-poly(hyroxyethyl methacrylate), poly(ethylene oxide)-blend poly(methyl methacrylate), poly(hydroxystyrene)-blend-poly(ethylene oxide)).

Typical inorganic sorbents suitable for the present invention include silicones, alumina, graphite, activated carbon, carbon fibers, diatomites, silica gel, glass, molecular sieve, zeolites, metal oxides, and others. All of the organic and inorganic sorbents can have additives (relatively small molecule additives, macromolecular additives, particulate additives) added to them. The additives can be thoroughly mixed into the matrix or can form separate phases. The inorganic sorbents in one embodiment of the present invention are necessarily incorporated into polymer nanofibers. The inorganic sorbents can be used alone or with other materials just like the polymeric and organic sorbents can be used alone or with other materials.

Additives (organic or inorganic) can be added to the polymer solution for electrospinning. Their size can range from ˜10 nm up to ˜100 micrometers. The additives can be added to the solvent before the polymer is added, then the mixture of particulates in the solvent is sonicated to distribute the particulates and reduce aggregation to produce particulates of desired size. Then the polymer material can be added to the solvent with particulates. Further mixing and sonication is performed as necessary to create a consistent mixture. Alternatively, if the additives are meant to be homogeneously mixed into the matrix, the mixture is mixed and/or sonicated until the mixture is homogeneous on a molecular scale.

Other examples according to various embodiments of the present invention for adding the sorbent (organic or inorganic) to the thermoelectric device surface include the following. Particulate sorbent material can be electrosprayed onto the surface, which has been pretreated with an adhesive to promote adhesion of the material to the surface, if the material does not inherently adhere to the thermoelectric device surface. Particulates can be added to the thermoelectric device surface by exposing the thermoelectric device surface to an aerosol of the particulate material, also using an adhesive if necessary. Inorganic fibers can be created by electrospinning a pre-inorganic material onto the surface, then treating the pre-inorganic material in such a way as to convert the pre-inorganic material to inorganic material, as is common in the electrospinning literature.

In one embodiment of the present invention, the fibers in the mat include multiple types of materials, so that multi-component dilute gas samples can be preconcentrated by one device. For example component A can be sorbed by material A1, and component B can be sorbed by material B1. Additionally, differences in sorption properties can be taken advantage of in order to separate as well as preconcentrate the dilute components. For example, components A and C are both sorbed by material A1, but component A desorbs at a lower temperature than C. The desorption process can then include two steps, one at a low temperature to desorb A then one at a high temperature to desorb C.

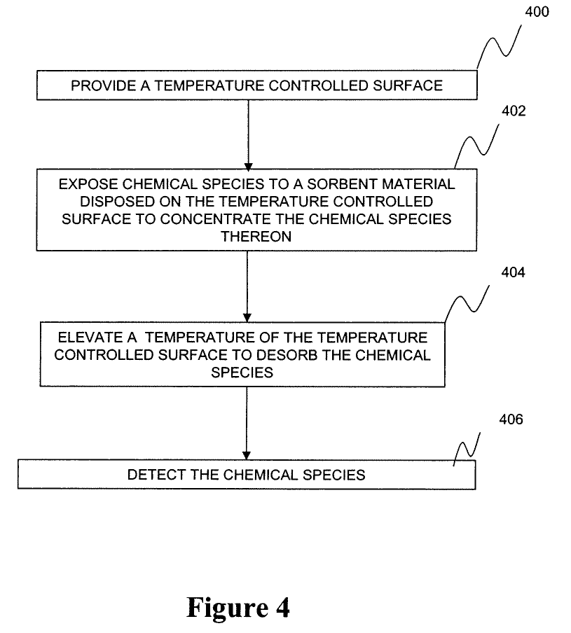

Hence, in one embodiment of the present invention, there is provided a method for concentrating chemical species. FIG. 4 is a flowchart depicting this method. At 400, a temperature controlled surface is provided as for example with the disclosed thermoelectric units or the disclosed alternative heating and cooling units. At 402, the chemical species is exposed to a sorbent material disposed on the temperature controlled surface to concentrate the chemical species thereon. At 404, the concentrated chemical species is desorbed by elevating a temperature of the temperature controlled surface. The method further includes, as shown in FIG. 4 at 406, detection of the chemical species.

At 400, the sorbent material can be cooled below room temperature to facilitate sorption of the chemical species from for example a gas supply carrying the chemical species. At 404, the sorbent material can be heated to a desorption temperature at which the chemical species desorbs.

At 402, a gas including the chemical species can flow across the sorbent material for a first duration that concentrates a quantity of the chemical species on the sorbent material, and at 404, the quantity of concentrated chemical species can be desorbed over a second duration shorter than the first duration. At 402, a gas including a first and second chemical species can flow over the sorbent material, and at 404 the sorbent material can be heated to a first temperature to desorb the first chemical species and to a second temperature to desorb the second chemical species.

At 402, a gas including the chemical species can flow through a chamber having at least one thermoelectric device temperature (or other temperature controlling device) controlling a temperature of the sorbent material. Further, after completing the exposure of the sorbent material to the gas including the chemical species (for example by reducing the temperature of the sorbent material to concentrate a quantity of the chemical species on the sorbent material), the chamber can be sealed and the sorbent material heated. Effluent containing the chemical species can be directed to a detector for detection of at least one of the chemical species or the class of chemical species.

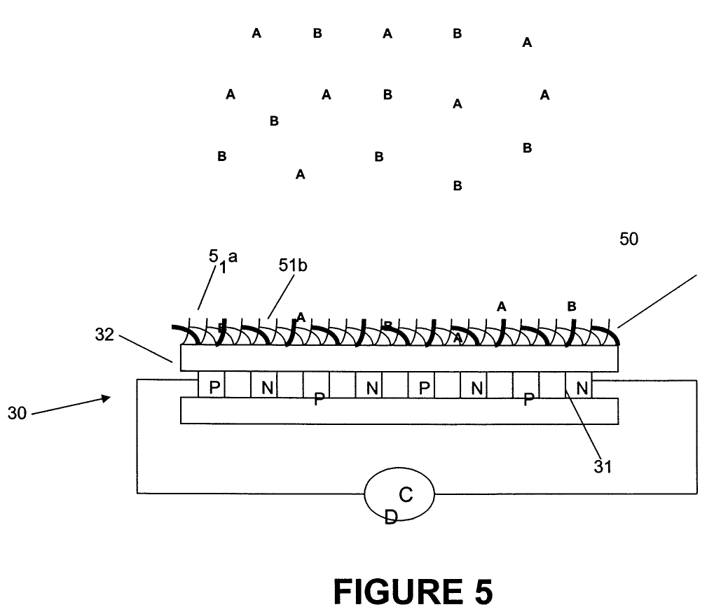

At 406, the chemical species can be detected and/or further analyzed by one of suitable detectors (for example, mass spectrometry, ion mobility or other spectrometry, flame ionization, thermal conductivity, electron capture, etc.). In one embodiment of the invention, as shown in FIG. 5, the nanofiber mat may be composed of more than one nanofiber material which has been electrospun onto the substrate of the electrothermal unit. Each of the nanofiber materials may have the ability to sorb a different chemical species of interest. Thus, nanofiber type 51a may be suitable for sorbing chemical species of interest A, whereas nanofiber type 51b, may be suitable for sorbing chemical species of interest B. Thus, a single thermal swing preconcentrator may have the ability to detect more than one chemical species.

In one embodiment of the present invention, the sorbent material includes porous fibers. Porous fibers provide an even higher surface area to volume ratio as compared to non-porous fibers of the same average diameter. Techniques such as disclosed by Sekimoto et al (U.S. Pat. No. 4,468,434) and Howard et al (U.S. Pat. No. 5,093,197), the entire contents of these patents are incorporated herein by reference, are applicable in the present invention. These techniques include for example forming fibers including a material susceptible to alkali etching. These techniques include for example extruding a fiber composed partially of a plasticizer and partially dissolving the plasticizer.

Desorption temperature for chemical species A and B can be the same or can be different.

### EXAMPLE

nanofiber 51a: poly(diphenylphenylene oxide)

chemical species A: pentane

nanofiber 51b: glass

chemical species B: eicosane

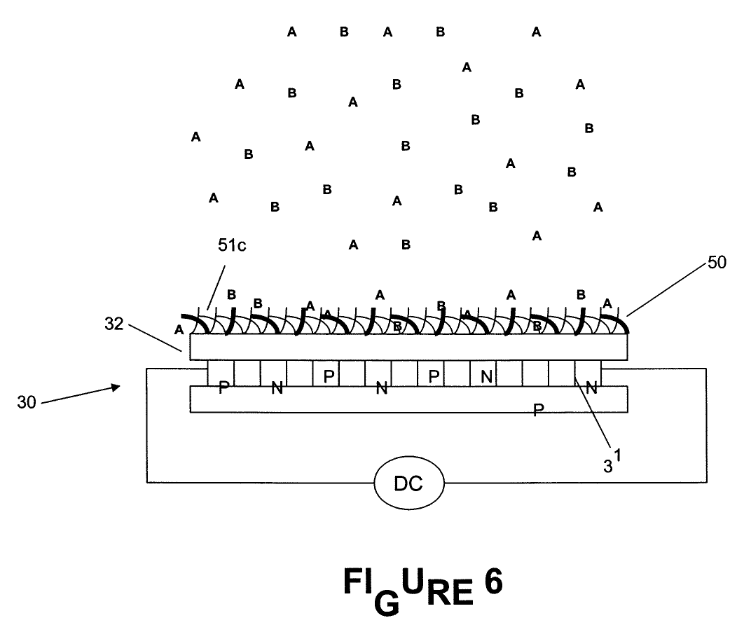

In another exemplary embodiment, as shown in FIG. 6, the nanofiber mat may be composed of a single nanofiber material which has the ability to sorb more than one chemical species of interest. Sorbent materials of the present invention such as the nanofibers discussed above and others can include carbon black in concentrations ranging up to 70%. The carbon black material provides a non-reactive high surface area material that can enhance sorption of the chemical species from the gas phase. The carbon black material can be added during the electrospinning by including the carbon black in the electrospun material or can be added as the electrospun fibers coalesce into a fiber mat or can be added after the formation of the fiber mat.

As shown in FIG. 6, in one embodiment of the present invention, nanofiber 51c may sorb chemical species A and B. Then depending on the properties of chemical species A and B, they may be desorbed by heating/cooling the substrate to a single temperature, or if A and B have different properties, the substrate may be heated/cooled to a first temperature T1 to desorb A and a second temperature T2 to desorb B.

### EXAMPLE

nanofiber 51c: poly(diphenylphenylene oxide)

chemical species A: chlorodifluoromethane

chemical species B: vinyl chloride

T1: appx 60-80° C.

T2: appx 100-120° C.

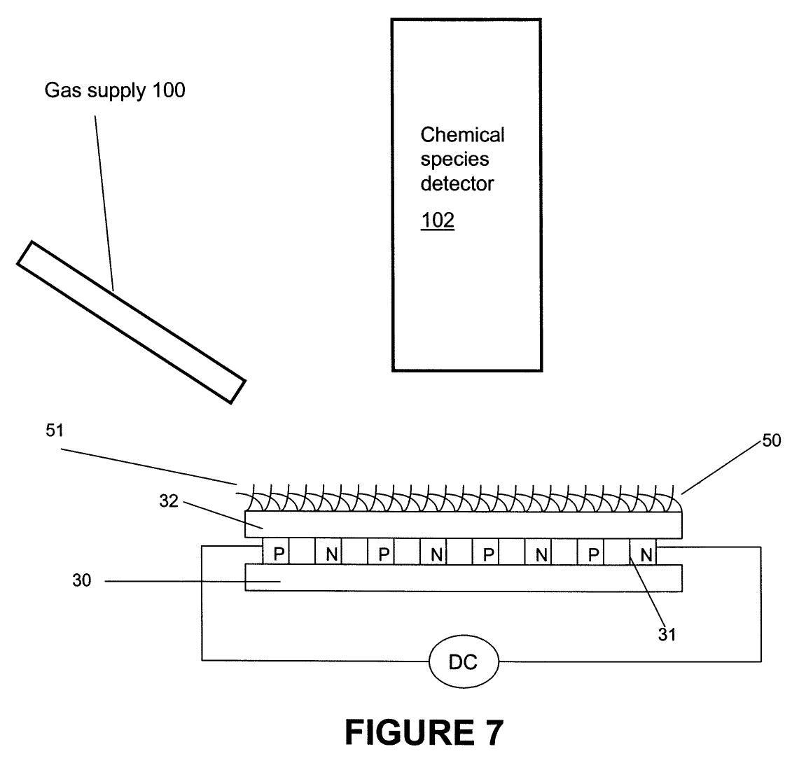

FIG. 7 is a schematic illustration of a preconcentrator system according to another embodiment of the invention. As illustrated in FIG. 7, the preconcentrator system includes a gas supply 100 for feeding chemical species to the thermal preconcentrator of FIG. 6. The thermoelectric unit (30, 31, and 32) has sorbent materials 50, 51 on the surface of the substrate 32, which when cooled adsorb or absorb the chemical species onto (and possibly in) the sorbent materials. As more of the gas supply is delivered, more of the chemical species are collected on the sorbent materials. At some point, the gas supply is stopped, and the substrate 32 is heated to desorp the collected species. At that time, a detector 102 samples the desorbed species for identification thereof.

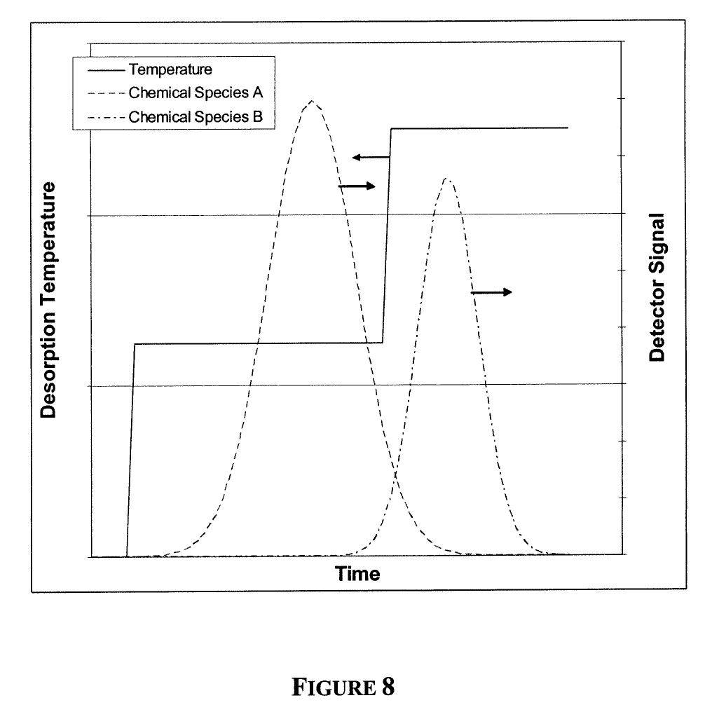

FIG. 8 is a schematic illustrating the desorption of separate species from a sorption material at different temperatures. In general, chemical species A and B can be sorbed by a single sorbent and released at the same or different temperatures, or sorbed in multiple sorbents and released at the same or different temperatures.

While the effect of the present invention has been demonstrated with electrospun fibers and nanofibers, the present invention can include the use of other sorption materials attached to the thermoelectric cooler that can accumulate a chemical species. For instance, the sorption materials can also include microfiber, nanoparticles, microparticles, other large surface area shapes. The accumulation and subsequent release is enhanced when the sorption materials have larger surface area to volume ratios.

The arrangement of multiple sorbent materials on the TE surface can be done in several ways, including but not limited to the following four examples. One method is to have multiple TE devices, each with one sorbent material. A second method is to have multiple swatches of sorbent on a single TE device. A third method is to have one swatch of multiple sorbents intermixed with each other or layered upon each other. The fourth method would be some combination of the first three. Other arrangements besides these are also possible.

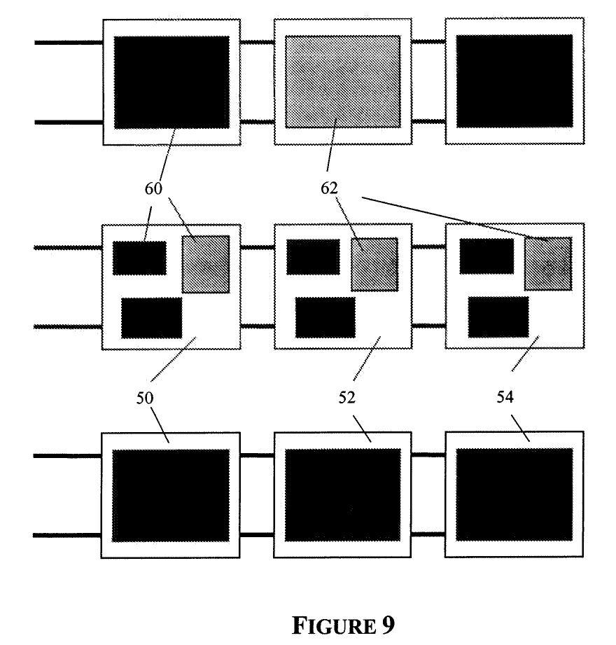

FIG. 9 shows three illustrative arrangements. As shown in FIG. 9, three thermoelectric units 50, 52, and 54 are arranged in series with a specific pattern of sorbent, for example sorbent A depicted as element 60 and sorbent B depicted as element 62. Other patterns or combinations of patterns are also possible, as are other numbers of TE units. The TE units also may be in series as shown or operate independently of each other.

Furthermore, in certain embodiments of the present invention, where subambient, ambient and slightly above ambient sorption/desorption temperatures (approximately −100° C. to approximately 40° C.) are desired, a heat sink can be added to the hot side of the thermoelectric unit to remove the excess heat and assure that the cold side remains at the desired temperature. A heat sink is not required or desired in all cases. If the gas being sampled is humid, the cold temperatures can cause freezing of water on the sorbent, in which case it is possible to direct the gas through a moisture trap before directing it to the preconcentrator in order to remove the moisture before it encounters the cold temperatures.

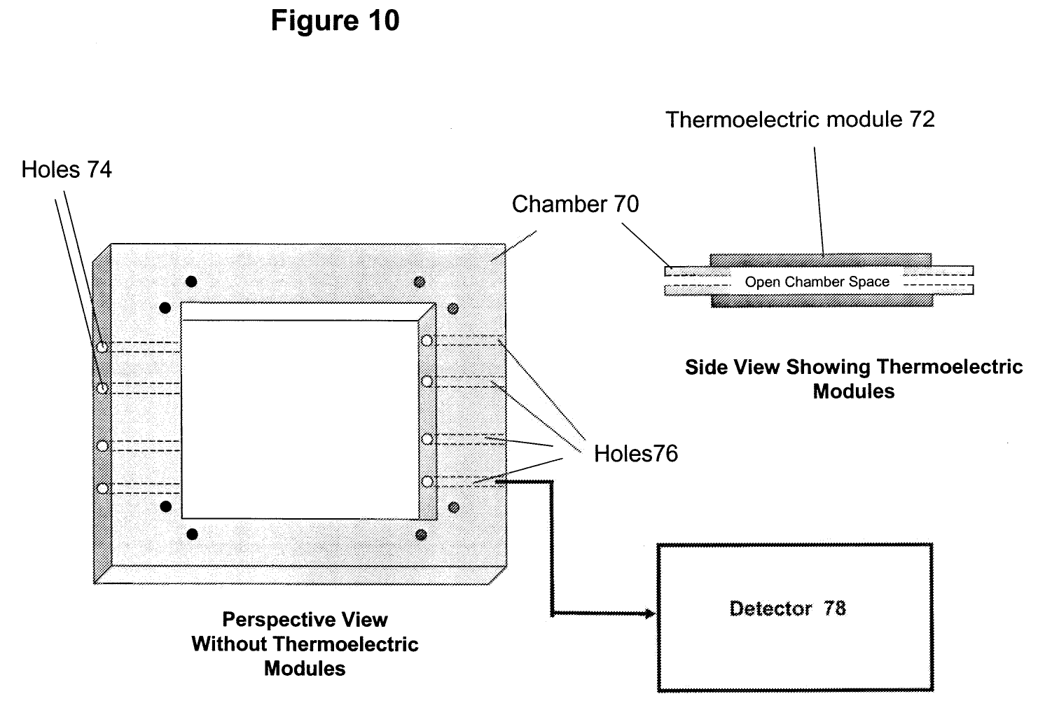

FIG. 10 is a schematic illustration of a preconcentrator chamber 70 according to one embodiment of the present invention. FIG. 10 shows a single chamber design that allows the use of multiple thermoelectric (TE) modules 72 (for example in the arrangements shown in the prior figures). A sorbent covered TE module 72 is situated in for example a rectangular central opening, and either a second sorbent covered TE module 72 is situated opposite to the first, or a similarly shaped non-sorbing material is situated opposite to the first to seal the central chamber.

One possible operating procedure is as follows. During sampling, the sampled gas is directed into the chamber through holes 74 across the sorbant surface(s) and out of the chamber through holes 76. During desorption, the inlet and outlet are both sealed shut and the TE temperature is changed to promote desorption. After the desorption cycle, the chamber with the concentrated analyte(s) is sampled. The concentrated sample is output through holes 76 and directed to a detector 78, such as for example a mass spectrometer, ion mobility or other spectrometer, flame ionization, thermal conductivity or electron capture detector, or a gas chromatograph for analysis of the chemical species or class.

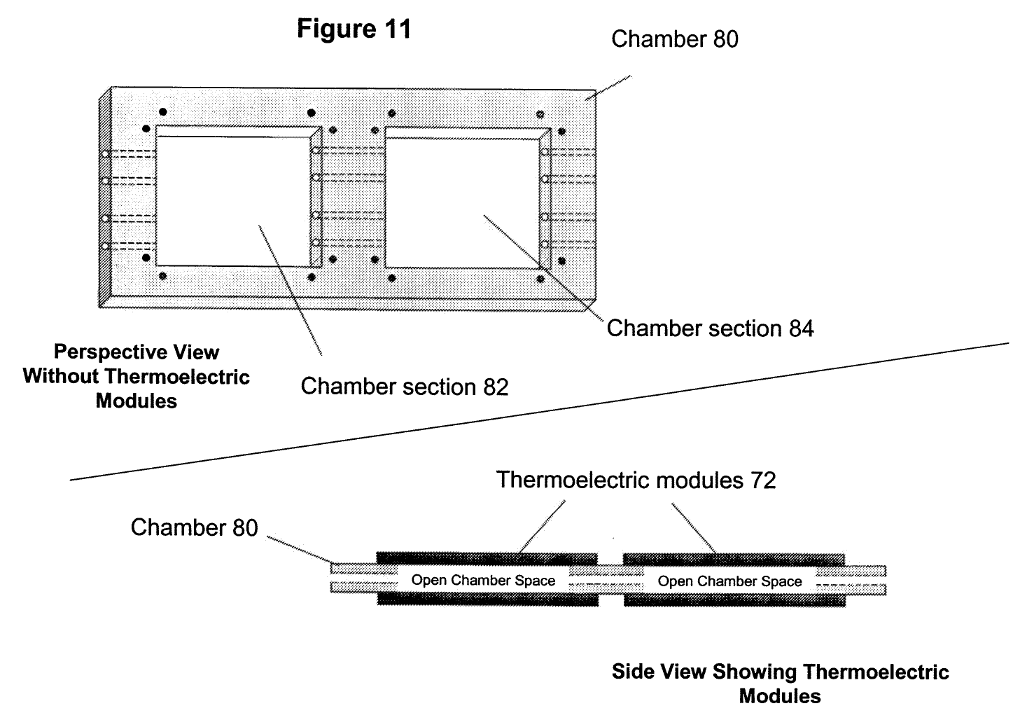

FIG. 11 is a schematic illustration of a preconcentrator chamber 80 according to one embodiment of the present invention. In FIG. 11, two chamber sections 82 and 84 permit for example up to four sorbent coated TE modules 72 to be used. One operating procedure is similar to the operating procedure discussed above. The gas being sampled is directed into chamber section 82 and chamber section 84 and thereby crosses multiple sorbent covered TE surface(s). During desorption, the chamber 80 is sealed while the TE temperatures are changed to promote desorption of the analyte. The concentrated analyte from both chamber sections 82 and 84 is sampled and directed to a detector.

Other variations include but are not limited to stacking the TE modules to increase the temperature range that is accessible, using multiple types of sorbents in various patterns on a single or on multiple TE modules, sampling the concentrated analyte(s) in the multi-chamber design as a whole or sampling each individual chamber separately, sampling the concentrated analyte(s) at multiple timepoints after the start of the desorption step, the use of multiple desorption temperatures, use of more than two chambers, and any combination of the above.

Using the following conditions, the sorption inlet, sorption outlet (cold) and desorbed (hot) concentrations were measured by GC:
Sorbent material is poly(2,6-diphenylene oxide) electrospun onto TE module surface,
Electrospinning conditions: 10% w/w polymer in 1:1 wt ratio methylene chloride:dimethylacetamide, 30 kV and 25 cm. (separation distance to collector) producing fibers of approximately 5 microns in diameter,
A Melcor™ model HT4-12-30 TE module,
Default sorption time is 2 minutes,
Default desorption time is 1 minute,
Default sorption temperature is approximately 5° C., and
Default desorption temperature is approximately 50° C.

In the following embodiment of the present invention, the sorption inlet concentration is the concentration of the inlet gas that is drawn over the sorbent material during the sorption (cold) cycle. The sorption outlet concentration is the concentration of the outlet gas that has been drawn over the sorbent material during the sorption (cold) cycle. The desorbed concentration is the concentration of the outlet gas after the desorption cycle. Increases in concentration by the device are measured in terms of percent recovery:

$$Percent Recovery = ( \frac{Area Count of VOC recovered after desorption}{\begin{matrix}Area Count of VOC present \\ in the gas stream during sorption\end{matrix}} ) \times 100$$

The denominator is related to the sorption inlet concentration, not the sorption outlet concentration. The numerator is related to the desorbed concentration.

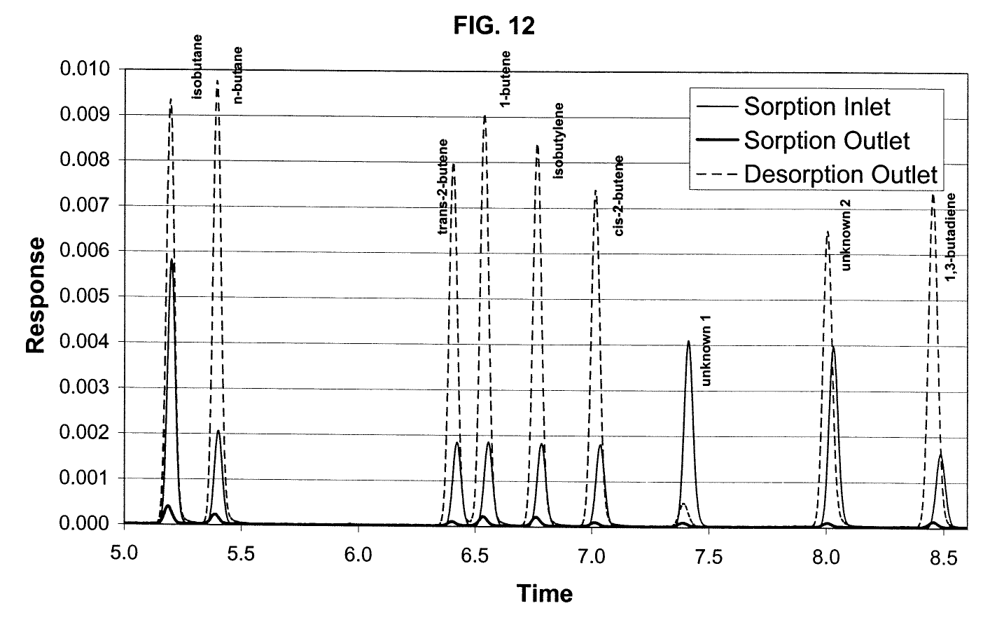

FIG. 12 is a graph of detected species in the gas phase detected by gas chromatography (GC) for the sorbent material specified above. The GC traces of the sorption inlet (black), sorption outlet (blue) and desorbed (red) samples are shown. In almost all cases, the detected species are concentrated by sorption on the nanofibers of the sorbent poly(2,6-diphenylene oxide) material in this example.

Specifically, FIG. 12 shows that, in all cases but one, the sorption inlet is the medium sized peak, the sorption outlet is the small peak, and the desorbed sample is the large peak. In one case, the third set of peaks from the right, the desorbed sample is the medium peak and the sorption inlet is the large peak. The VOC identities from left to right are: isobutane, n-butane, trans-2-butene, 1-butene, isobutylene, cis-2-butene, unknown 1, unknown 2, and 1,3-butadiene.

The following are tables depicting a summary of percent recovery values obtained on various VOCs: Table I shows (according to the equation above) the % recovery for various gas species sorbed onto the sorbent poly(2,6-diphenylene oxide) material discussed above. In the first illustration, the temperature controlled surface of the TE module was maintained at 5° C. during the sorption and elevated to 50° C. during desorption. Desorption time was 1 minute, while sorption times are as indicated.

TABLE I

| | % Recovery | % Recovery |
|---|---|---|
| | 1 Minute | 2 Minute |
| Compound | Sorption | Sorption |
| n-butane | 240 | 370 |
| trans-2-butene | 270 | 380 |
| 1-butene | 330 | 410 |
| isobutylene | 320 | 380 |
| cis-2-butene | 280 | 370 |
| 1,3-butadiene | 410 | 430 |
| ethylacetylene | 240 | 380 |
| 2-methylpentane | 10 | 20 |
| 3-methylpentane | 10 | 30 |
| vinyl chloride | 190 | 390 |

In the second illustration, the temperature controlled surface of the TE module was maintained at 5° C. during the sorption and elevated to the respective temperatures shown during desorption. These results show that sorption time (as for example in an accumulation mode where the gas species accumulate on the sorbent material prior to desorption) as well as desorption temperature can be used to recover the sorbed (or collected) chemical species. Other or additional control variables useful in the present invention include desorption time, gas flow rates, cavity volumes, and sorption temperature.

TABLE II
2 Minute Sorption, 1 Minute Desorption

| | Temperature (° C.): | | | | |
|---|---|---|---|---|---|
| | 26 | 32 | 38 | 44 | 49 |
| | TE Supply Voltage | | | | |
| | 1 | 2 | 3 | 4 | 5 |
| Compound | % Recovery | | | | |
| isobutane | 30 | 70 | 80 | 130 | 120 |
| n-butane | 100 | 180 | 220 | 380 | 400 |
| trans-2-butene | 70 | 130 | 140 | 310 | 410 |
| 1-butene | 100 | 190 | 230 | 390 | 410 |
| isobutylene | 90 | 180 | 210 | 360 | 370 |
| cis-2-butene | 60 | 120 | 150 | 290 | 390 |
| 1,3-butadiene | 80 | 150 | 180 | 340 | 400 |
| ethyl acetylene | 40 | 70 | 100 | 220 | 360 |
| 2-methylpentane | 0 | 0 | 10 | 10 | 30 |
| 3-methylpentane | 0 | 10 | 10 | 20 | 30 |

Numerous modifications and variations of the present invention are possible in light of the above teachings. It is therefore to be understood that within the scope of the appended claims, the invention may be practiced otherwise than as specifically described herein.

1. A thermal preconcentrator unit comprising:
a thermoelectric device having a temperature controlled surface;
a sorbent material disposed on and in thermal contact with the temperature controlled surface, and configured to concentrate a chemical species, and
said thermoelectric device configured to cool and heat the temperature controlled surface to promote sorption and desorption of the chemical species onto and from the sorbent material.

2. The unit of claim 1, wherein the sorbent material comprises at least one of a fiber mat, a plurality of particles, a film, and a combination thereof.

3. The unit of claim 1, wherein the sorbent material comprises at least one of a nanofiber mat, a microfiber mat, a plurality of nanoparticles, a plurality of microparticles, a film, and a combination thereof.

4. The unit of claim 1, wherein the sorbent material comprises at least one of an organic polymer, an inorganic material, and a non-polymeric inorganic material.

5. The unit of claim 1, wherein the sorbent material is configured to concentrate a class of chemical species.

6. The unit of claim 1, wherein the sorbent material comprises electrospun fibers disposed on the substrate.

7. The unit of claim 6, wherein the temperature controlled surface has a roughness that is at least 5 % of an average fiber diameter of the electrospun fibers.

8. The unit of claim 6, wherein the electrospun fibers have an average fiber diameter of less than 500 nm.

9. The unit of claim 6, wherein the electrospun fibers have an average fiber diameter of less than 100 nm.

10. The unit of claim 1, wherein the sorbent material includes carbon black.

11. The unit of claim 10, wherein the carbon black comprises a concentration of up to 70% of the sorbent material.

12. The unit of claim 1, wherein the sorbent material includes a porous fiber.

13. The unit of claim 1, wherein the temperature controlled surface includes an adhesion promoter bonding the sorbent to the surface.

14. The unit of claim 1, wherein the sorbent material comprises sections having a plurality of materials having respective sorption and desorption properties for different chemical species.

15. The unit of Clam 14, wherein the sections are designated for each of the plurality of materials.

16. The unit of claim 1, wherein the sorbent material comprises a plurality of materials mixed together having respective sorption and desorption properties for different chemical species or classes of chemical species.

17. The unit of claim 1, wherein the sorbent material comprises a plurality of materials having respective sorption and desorption properties for different chemical species or classes of chemical species and disposed on respective thermoelectric device modules.

18. The unit of claim 1, wherein the thermoelectric device comprises a substrate detachable from the thermoelectric device.

19. A thermal preconcentrator unit comprising:
a temperature controlled surface;
a nanonfiber medium having nanofibers of an average fiber diameter less than 1 micron, disposed on and in thermal contact with the temperature controlled surface, and configured to concentrate a chemical species upon sorption on the nanofiber medium, and
a heating and cooling device configured to cool and heat the temperature controlled surface to promote sorption and desorption of the chemical species onto and from the nanofiber medium.

20. The unit of claim 19, wherein the nanonfiber medium comprises at least one of an organic polymer, an inorganic material, and a non-polymeric inorganic material.

21. The unit of claim 19, wherein the nanonfiber medium is configured to concentrate a class of chemical species.

22. The unit of claim 19, wherein the nanonfiber medium comprises electrospun nanofibers disposed on the substrate.

23. The unit of claim 22, wherein the temperature controlled surface has a roughness that is at least 5% of an average fiber diameter of the electrospun nanofibers.

24. The unit of claim 22, wherein the electrospun nanofibers have an average fiber diameter of less than 500 nm.

25. The unit of claim 22, wherein the electrospun nanofibers have an average fiber diameter of less than 100 nm.

26. A method for concentrating a chemical species, comprising:
providing a thermoelectric temperature controlled surface;
exposing the chemical species to a sorbent material disposed on the temperature controlled surface to concentrate the chemical species thereon; and
desorbing the chemical species from the sorbent material.

27. The method of claim 26, further comprising:
detecting at least one of the chemical species or a class of the chemical species.

28. The method of claim 27, wherein detecting comprises identifying the chemical species by any one of mass spectrometry, ion mobility, flame ionization, thermal conductivity, and electron capture detection.

29. The method of claim 26, wherein exposing comprises:
cooling the sorbent material below room temperature.

30. The method of claim 29, wherein cooling comprises thermoelectrically cooling the temperature controlled surface.

31. The method of claim 26, wherein desorbing comprises:
heating the sorbent material to a desorption temperature at which the chemical species or a class of the chemical species desorbs.

32. The method of claim 26, wherein
exposing comprises flowing a gas including the chemical species across the sorbent material for a first duration that concentrates a quantity of the chemical species on the sorbent material, and
desorbing comprises desorbing the quantity of concentrated chemical species over a second duration.

33. The method of claim 26, wherein
exposing comprises flowing a gas including a first chemical species and a second chemical species, and
desorbing comprises heating the sorbent material to a first temperature to desorb the first chemical species and to a second temperature to desorb the second chemical species.

34. The method of claim 26, wherein
exposing comprises flowing a gas including at least three chemical species, and
desorbing comprises heating the sorbent material to a first temperature to desorb a first of the chemical species and to a second temperature to desorb a second of the chemical species and to a third temperature to desorb a third of the chemical species.

35. The method of claim 26, wherein exposing comprises:
flowing a gas including the chemical species through a chamber including the temperature controlled surface.

36. The method of claim 35, further comprising:
setting the temperature of the sorbent material to a first temperature less than a second temperature to concentrate a quantity of the chemical species on the sorbent material;
sealing the chamber and setting the temperature of the sorbent material to the second temperature to desorb the chemical species; and
detecting the chemical species by way of an effluent from the chamber.

37. A method for concentrating a chemical species, comprising:
providing a temperature controlled surface;
exposing the chemical species to a nanonfiber medium disposed on the temperature controlled surface to concentrate the chemical species thereon, said nanofiber medium having nanofibers of an average fiber diameter less than 1 micron.

38. A system for concentrating and detecting a chemical species, comprising:
a gas feed configured to supply the chemical species;
a thermoelectric device having a temperature controlled surface;
a sorbent material disposed on and in thermal contact with the temperature controlled surface and configured to concentrate the chemical species;
said thermoelectric device configured to cool and heat the temperature controlled surface to promote sorption and desorption of chemical species onto and from the sorbent material; and
a detector configured to detect the chemical species upon desorption from the sorbent material.

39. The system of claim 38, wherein the detector is configured to detect at least one of the chemical species and a class of the chemical species desorbed from the temperature controlled surface.

40. The system of claim 38, wherein the detector comprises at least one of mass spectrometry, ion mobility, flame ionization, thermal conductivity, and electron capture detection.

41. The system of claim 38, further comprising:
a chamber enclosing the thermoelectric device and configured to contain the chemical species upon said desorption.

42. The system of claim 38, further comprising:
a chamber enclosing plural thermoelectric devices having respective surfaces including respective sorbent materials, the chamber configured to contain the chemical species upon said desorption.
